(19) United States
(12) Patent Application Publication
(10) Pub. No.: US 2010/0232843 A1
(43) Pub. Date: Sep. 16, 2010

(54) INTERMEDIATE TRANSFER BELT AND IMAGE-FORMING APPARATUS

(75) Inventor: Ryouji Kouno, Okazaki-shi (JP)

Correspondence Address: BUCHANAN, INGERSOLL & ROONEY PC, POST OFFICE BOX 1404, ALEXANDRIA, VA, 22313-1404, US

(73) Assignee: Konica Minolta Business Technologies, Inc., Chiyoda-ku (JP)

(21) Appl. No.: 12/721,812

(22) Filed: Mar. 11, 2010

(30) Foreign Application Priority Data
Mar. 12, 2009 (JP) 2009-059610

(51) Int. Cl. G03G 15/01

(52) U.S. Cl. 399/302

(57) ABSTRACT

An intermediate transfer belt provided with an elastic layer and an outermost surface layer formed on the elastic layer, with the outermost surface layer being prepared as inorganic compound layer having a surface roughness Rz from 2 to 20 μm, and an image-forming apparatus equipped with the intermediate transfer belt.

This application is based on application No. 2009-059610 filed in Japan, the contents of which are hereby incorporated by reference.

### BACKGROUND OF THE INVENTION

1. Field of the Invention

The present invention relates to an intermediate transfer belt that is used for an intermediate transfer member upon transferring a toner image formed on a surface of a photosensitive member onto a recording material such as paper in an image-forming apparatus by use of an electrophotographic method, such as a copying machine, a facsimile and a laser printer, and to an image-forming apparatus provided with such an intermediate transfer belt.

2. Description of the Related Art

In recent years, in an image-forming apparatus using an electrostatic process, the intermediate transfer belt has been widely used to satisfy demands for high-quality images to be formed on various kinds of paper in various modes. As the intermediate transfer belt, in general, a resin belt typically made from polyimide is widely used because of its high picture-image quality, long service life and highly stable characteristics. With respect to an intermediate transfer belt cleaning device, a blade system having a high cleaning capability has been widely used, by taking surface properties and the like of the resin belt into consideration. Recently, in order to provide higher image quality and stability or the like of the cleaning capability by the use of the blade system, toner has been changed into a smaller particle size and the shape of the toner has been changed into a non-spherical shape. However, in the case of the intermediate transfer belt made from a resin, an image loss phenomenon caused by a transferring process due to such a change in the toner has been raised as a serious problem. The image loss phenomenon refers to a phenomenon in which, since a great pressure is applied to an image upon transferring the image, the toner is subjected to a stress deformation, with a result that an aggregating force among the toner particles increases to cause one portion of an image to remain on the image supporting member without being transferred, and this phenomenon becomes conspicuous, in particular, in character images, line images and the like. In the case of the resin belt, since a high pressure is given to an image upon transferring the image, this image-loss problem becomes particularly conspicuous.

In order to prevent this image-loss problem, in recent years, an elastic intermediate transfer belt in which an elastic layer is used as its surface layer has been mainly used in place of the intermediate transfer belt using a resin. The elastic intermediate transfer belt has a soft surface layer because of its elasticity, and since the pressure to be applied to the toner at a transferring unit can be reduced, it has been known that the elastic intermediate transfer belt is effective for preventing the image-loss phenomenon. Since it exerts good adhesion to paper in the secondary transferring unit, it is possible not only to improve the transferring efficiency to paper in general, but also to enhance the transferring property to cardboard as well as the transferring property to paper having surface irregularities.

In the case where the blade system is used upon cleaning the elastic intermediate transfer belt, since the surface layer has an elastic property, a contact load of a cleaning blade relative to the elastic intermediate transfer belt becomes greater, and the top edge of the cleaning blade is caught into the belt surface layer. As a result, an unstable behavior of the top edge of the cleaning blade may cause cleaning defects, or the increase in frictional force between the belt and the cleaning blade may cause problems of peeling, chattering and squeaking of the cleaning blade, or various disadvantages such as scratches on the elastic belt surface layer and occurrence of toner fusion or the like; and thereby, the image quality might be impaired.

In order to avoid these problems, a technique has been proposed in which an organic layer containing a urethane resin or the like is formed on the elastic layer surface of the intermediate transfer belt (Japanese Patent-Application Laid-Open No. 2003-131492). However, in the case where such an intermediate transfer belt is used, since the organic layer is worn out during endurance printing operations exceeding 200,000 sheets, filming on the belt surface is not sufficiently suppressed.

An object of the present invention is to provide an intermediate transfer belt that can suppress an occurrence of filming even in the case of endurance printing operations and an image-forming apparatus using such a belt.

### BRIEF SUMMARY OF THE INVENTION

The present invention relates to an intermediate transfer belt, comprising:

an elastic layer; and

an outermost surface layer formed on the elastic layer,

wherein the outermost surface layer is an inorganic compound layer having a surface roughness Rz from 2 to 20 μm, and to an image-forming apparatus having such an intermediate transfer belt.

The present invention also relates to an image-forming apparatus, comprising:

an image-forming unit having an image-supporting member on which a toner image is formed; and

an intermediate transfer belt on which the toner image is transferred from the image-supporting member,

wherein the intermediate transfer belt comprises an elastic layer and an outermost surface layer formed on the elastic layer and containing an inorganic compound layer with a surface roughness Rz from 2 to 20 μm.

### BRIEF DESCRIPTION OF THE DRAWINGS

FIG. 1(A) is a schematic cross-sectional view showing one example of an intermediate transfer belt according to the present invention, and FIG. 1(B) is a schematic cross-sectional view showing another example of the intermediate transfer belt according to the present invention.

FIG. 2 is a schematic enlarged view showing a portion close to a surface of one example of an intermediate transfer belt according to the present invention, so as to explain a mechanism for preventing cracks.

FIG. 3 is a schematic enlarged view showing a portion close to the surface in an intermediate transfer belt whose surface roughness is too small, so as to explain a mechanism in which cracks occur.

FIG. 4(A) is a schematic enlarged view showing a portion close to the surface in an intermediate transfer belt whose surface roughness is too small, so as to explain a mechanism in which filming occurs, and FIG. 4(B) is a schematic enlarged view showing a portion close to the surface in an intermediate transfer belt whose surface roughness is too large, so as to explain a mechanism in which filming occurs.

FIG. 5 is a schematic structural view showing one example of a first manufacturing device used for manufacturing an outermost surface layer.

FIG. 6 is a schematic structural view showing another example of the first manufacturing device for manufacturing the outermost surface layer.

FIG. 7 is a schematic structural view showing a first plasma film-forming device used for manufacturing the outermost surface layer by using plasma, and corresponds to a portion mainly extracted from FIG. 5 along a broken line.

Both of FIGS. 8(a) and 8(b) are schematic views showing examples of roll electrodes.

FIG. 9 is a schematic structural view showing one example of an image-forming apparatus according to the present invention.

### DETAILED DESCRIPTION OF THE INVENTION

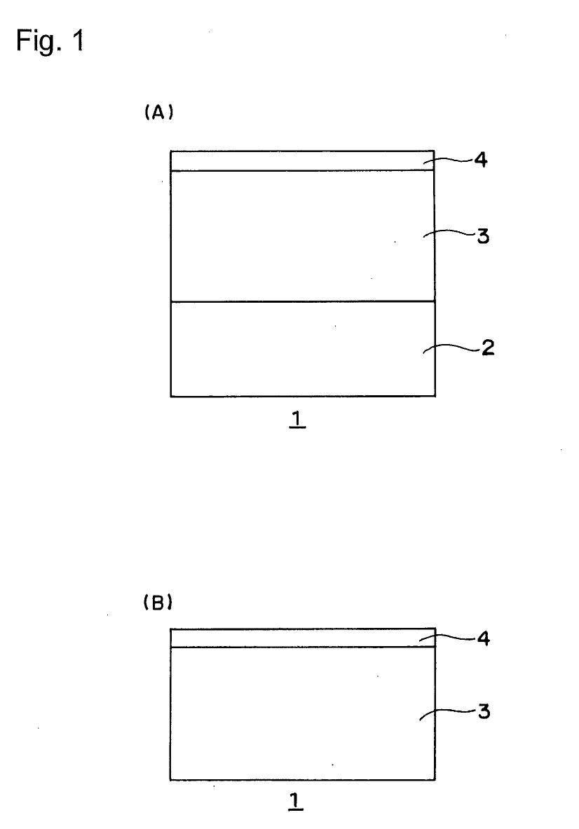

An intermediate transfer belt according to the present invention is provided with an elastic layer and an outermost surface layer formed on the elastic layer, and may have another layer, for example, a so-called base layer. More specifically, an intermediate transfer belt 1 according to the present invention may have a structure in which an elastic layer 3 and an outermost surface layer 4 are successively formed on a base layer 2, as shown in FIG. 1(A), or may have a structure in which the outermost surface layer 4 is formed on the elastic layer 3 without using the base layer.

Outermost Surface Layer

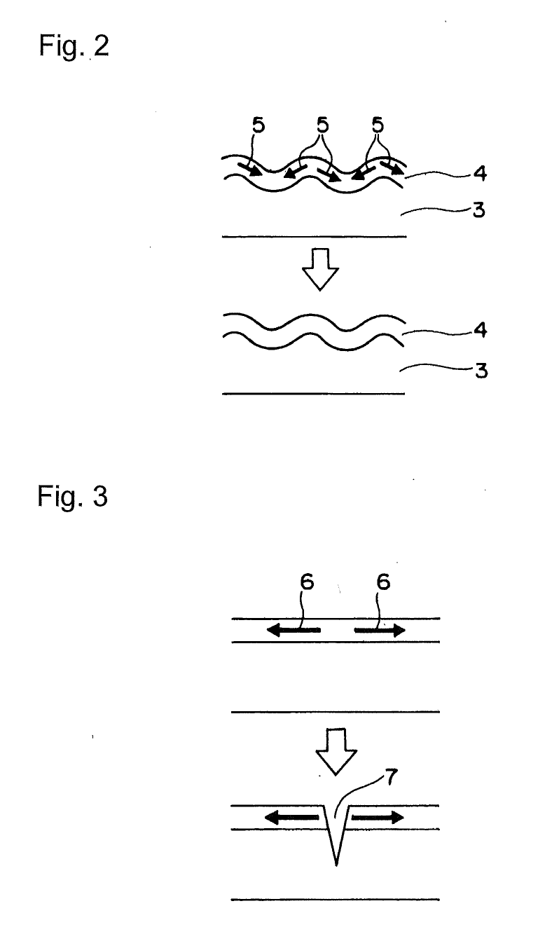

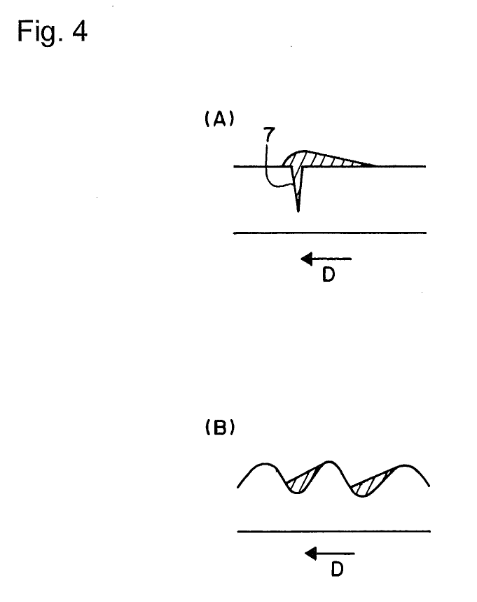

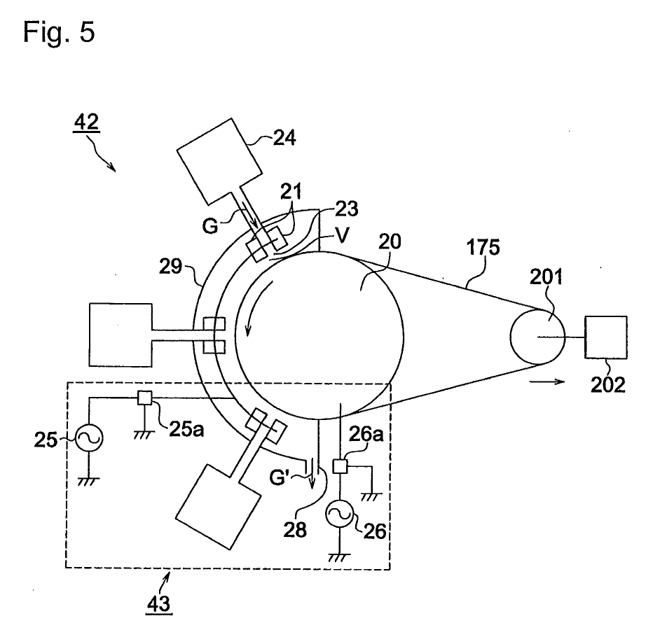

In the present invention, the outermost surface layer 4 is an inorganic compound layer having a surface roughness Rz of 2 to 20 μm, preferably, 2 to 10 μm. By this structure, as shown in FIG. 2, an inner stress 5 in the outermost surface layer 4 is scattered so that the strength is improved consequently to suppress an occurrence of a crack. Even if a crack occurs in the outermost surface layer, since the crack never reaches the elastic layer, toner, external additives and paper powder can be easily removed by cleaning means for the intermediate transfer belt. Deposition of the toner and external additives into concave portions on the outermost surface of the outermost surface layer 4 is effectively suppressed. As a result, it is considered that toner filming onto the belt surface can be suppressed. By setting the Rz value within the preferable range mentioned above, the generation of filming can be more effectively suppressed. In the case where the Rz value of the outermost surface layer becomes too small, since an inner stress 6 is easily concentrated as shown in FIG. 3, and since the difference between the hardness of the outermost surface layer and the hardness of the elastic layer located right beneath the outermost surface layer becomes too large, a crack 7 that reaches the elastic layer occurs. Upon occurrence of such a crack 7, as shown in FIG. 4(A), toner, external additives and paper powder are deposited thereon with the crack 7 serving as a starting point, and since it becomes difficult for the cleaning means for the intermediate transfer belt to carry out the removing process, filming occurs. Upon occurrence of filming, the surface resistance value increases in the corresponding occurrence area, to cause a drop in the toner transferring rate, and the subsequent degradation of image density. In the case where the Rz value of the outermost surface layer is too large, even upon generation of a crack, since the crack is very small, no filming is generated due to the crack. However, since each concave portion is comparatively large, toner, external additives and paper powder are deposited on the hillside in the concave portion, as shown in FIG. 4(B), making it difficult for the cleaning means for the intermediate transfer belt to carry out the removing process. As a result, filming occurs. FIG. 2 is a schematic enlarged view showing a portion close to a surface of one example of an intermediate transfer belt according to the present invention. FIG. 3 is a schematic enlarged view showing a portion close to the surface in an intermediate transfer belt whose surface roughness is too small. FIG. 4(A) is a schematic enlarged view showing a portion close to the surface in the intermediate transfer belt whose surface roughness is too small, which describes a mechanism in which filming occurs, and FIG. 4(B) is a schematic enlarged view showing a portion close to the surface in an intermediate transfer belt whose surface roughness is too large. In FIGS. 4(A) and 4(B), D indicates the belt traveling direction.

In the present specification, the surface roughness Rz is represented by an average value of measured values obtained at arbitrary ten points by a Surfcom 480A (made by Tokyo Seimitsu Co., Ltd.). The surface roughness Rz is not necessarily required to be measured by the above-mentioned device, and any device may be used for the measurements, as long as it can measure based upon the same principle and rule as those of the device.

The surface roughness Rz of the outermost surface layer can be controlled by adjusting the surface roughness of the elastic layer surface on which the outermost surface layer is formed. For example, by increasing the surface roughness of the elastic layer, the surface roughness of the outermost surface layer is increased. By reducing the surface roughness of the elastic layer, the surface roughness of the outermost surface layer is reduced. In the present invention, since the outermost surface layer is formed with a thickness as will be described later, the surface roughness of the elastic layer, as it is, is normally reflected in its surface roughness.

Although not particularly limited as long as the objective of the present invention is achieved, the thickness of the outermost surface layer is normally set in a range from 0.05 to 1.0 μm, preferably, from 0.05 to 0.5 μm.

From the viewpoint of further suppressing the occurrence of filming, the hardness of the outermost surface layer is preferably set in a range from 0.5 to 20 GPa, more preferably, from 1 to 15 GPa.

In the present specification, the hardness of the outermost surface layer is indicated by an average value of measured values obtained at arbitrary ten points through a nano-indentation method by using a NANO Indenter XP/DCM (made by MTS Systems Corporation/MTS NANO Instruments).

The hardness of the layer, which depends on the kinds of materials that form the layer, can be controlled by adjusting the thickness of the layer. For example, by increasing the thickness, the hardness is reduced.

Examples of inorganic compounds used for forming the outermost surface layer include: metal oxides, such as silicon oxide, titanium oxide, aluminum oxide, zinc oxide and zirconium oxide; and metal nitrides, such as silicon nitride.

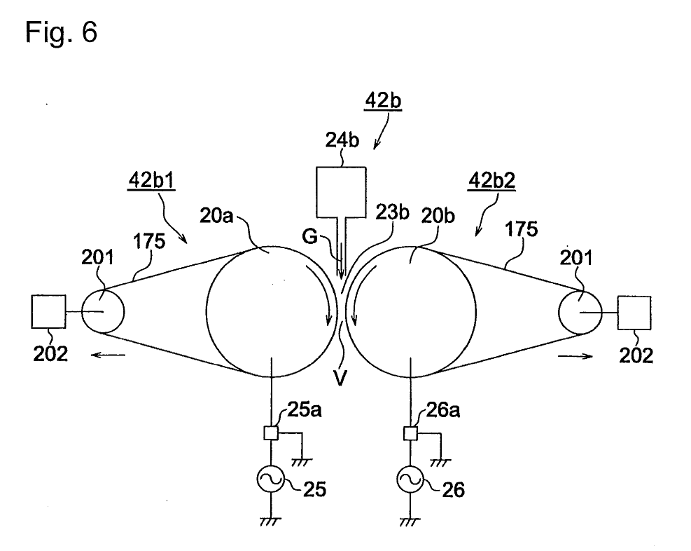

The outermost surface layer may be formed by using the following method. FIG. 5 is an explanatory view showing a first manufacturing device used for manufacturing the outermost surface layer. A manufacturing device 42 for the outermost surface layer (direct method in which a charging space and a thin-film deposition area are substantially the same), which forms an outermost surface layer 4 on the surface of a belt precursor 175 on which the outermost surface layer is to be formed, is provided with a roll electrode 20 and a driven roller 201 that rotate in an arrow direction, with the belt precursor 175 having an endless shape being passed thereon, and an atmospheric-pressure plasma CVD device 43 serving as a film-forming device for forming the outermost surface layer 4 on the surface of the belt precursor 175. In the case where an intermediate transfer belt having a structure shown in FIG. 1(A) is produced, the belt precursor 175 is formed into an endless belt shape in which an elastic layer 3 is formed on a base member 2, and in the case where an intermediate transfer belt having a structure shown in FIG. 1(B) is produced, it is formed into an endless belt shape made of the elastic layer 3.

The atmospheric-pressure plasma CVD device 43 is provided with at least one set of fixed electrodes 21 disposed on the periphery of the roll electrode 20, a discharge space 23 forming an opposing area between the fixed electrodes 21 and the roll electrode 20 in which a discharge is executed, a mixed-gas supply device 24 that generates a mixed gas G including at least a material gas and a discharge gas, and supplies the mixed gas G to the discharge space 23, a discharge container 29 that suppresses air from flowing into the discharge space 23 or the like, a first power supply 25 connected to the fixed electrode 21, a second power supply 26 connected to the roll electrode 20, and an exhaust unit 28 that discharges an used exhaust gas G′.

The mixed-gas supply device 24 supplies a mixed gas of a material gas used for forming the outermost surface layer and a nitrogen gas or a rare gas, such as an argon gas, to the discharge space 23. The driven roller 201 is pressed in an arrow direction by a tension applying means 202 so that a predetermined tension is given to the belt precursor 175. The tension applying means 202 is designed to release the applied tension upon exchanging the belt precursor 175 or the like so as to easily exchange the belt precursor 175 or the like. The first power supply 25 outputs a voltage with a frequency of ω1 and the second power supply 26 outputs a voltage with a frequency of ω2 so that an electric field V in which the frequencies of ω1 and ω2 are multiplexed is generated in the discharge space 23 by these voltages. Thus, the mixed gas G is formed into plasma by the electric field V so that a film (outermost surface layer 4) derived from the material gas contained in the mixed gas G is deposited on the surface of the belt precursor 175. Another mode may be proposed in which, among a plurality of fixed electrodes, by using those fixed electrodes located on the downstream side in the rotation direction of the roll electrode and the mixed gas supply device, the outermost surface layers 4 are deposited in a manner so as to be stacked so that the thickness of the outermost surface layers 4 may be adjusted. Among a plurality of fixed electrodes, by the fixed electrode located on the farthest downstream side in the rotation direction of the roll electrode and the mixed gas supply device, the outermost surface layers 4 are deposited, while by using the other fixed electrodes located on the upper stream side and the mixed gas supply device, another layer, for example, such as an adhesion layer, for improving the adhesive property between the outermost surface layer 4 and the belt precursor 175 may be formed. In order to improve the adhesive property between the outermost surface layer 4 and the belt precursor 175, a gas supply device for supplying a gas, such as argon, oxygen or the like, and a fixed electrode may be formed on the upstream side of the fixed electrode and the mixed gas supply device used for forming the outermost surface layer 4 so that a plasma process is carried out so as to activate the surface of the belt precursor 175. As described above, the endless belt precursor is passed over one pair of rollers, and one of the paired rollers is used as one of paired electrodes, and at least one fixed electrode serving as the other electrode is placed on the outside of the outer circumferential face of the roller used as one of the electrodes so that, between these paired electrodes, an electric field is generated under the atmospheric pressure or a pressure near the atmospheric pressure to exert a plasma discharge; thus, by depositing and forming a thin film on the surface of the belt precursor, it becomes possible to manufacture an intermediate transfer belt having high durability.

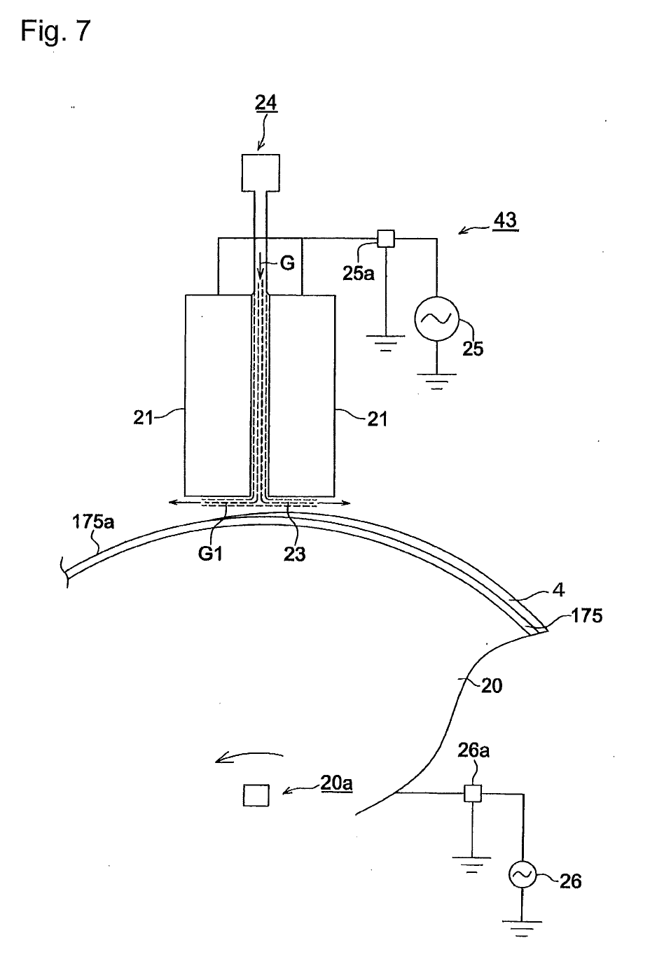

FIG. 6 is an explanatory view showing a second manufacturing device used for manufacturing the outermost surface layer. The second manufacturing device 42b for the outermost surface layer, which simultaneously forms outermost surface layers on a plurality of belt precursors, is mainly configured by a plurality of film forming devices 42b1 and 42b2 that form outermost surface layers on the belt precursors. The second manufacturing device 42b (modified system of the direct system in which a discharge and a thin-film-depositing process are carried out between the opposing roll electrodes) is provided with the first film-forming device 42b1 and the second film-forming device 42b2 that are disposed substantially in a mirror image manner, with a predetermined gap therebetween, and a mixed gas supply device 24b, disposed between the first film-forming device 42b1 and the second film-forming device 42b2, that generates a mixed gas G containing at least a material gas and a discharge gas, and supplies the mixed gas G to a discharge space 23b. The first film-forming device 42b1 is provided with a roll electrode 20a and a driven roller 201 that rotate in an arrow direction, with the belt precursor 175 having an endless shape being passed thereon, as well as a tension applying means 202 that pulls the driven roller 201 in the arrow direction and a first power supply 25 that is connected to the roll electrode 20a, while the second film-forming device 42b2 is provided with a roll electrode 20b and a driven roller 201 that rotate in an arrow direction, with the belt precursor 175 having an endless shape being passed thereon, as well as a tension applying means 202 that pulls the driven roller 201 in the arrow direction and a second power supply 26 that is connected to the roll electrode 20b. The second film-forming device 42b has a discharge space 23b in which a discharge is exerted within an opposing area between the roll electrode 20a and the roll electrode 20b.

The mixed-gas supply device 24b supplies a mixed gas of a material gas used for forming the outermost surface layer and a nitrogen gas or a rare gas, such as an argon gas, to the discharge space 23b. The first power supply 25 outputs a voltage with a frequency of ω₁ and the second power supply 26 outputs a voltage with a frequency of ω₂ so that an electric field V in which the frequencies of ω₁ and ω₂ are multiplexed is generated in the discharge space 23b by these voltages. Thus, the mixed gas G is formed into plasma (exited) by the electric field V so that the surfaces of the belt precursor 175 of the first film-forming device 42b1 and the belt precursor 175 of the second film-forming device 42b2 are exposed to the mixed gas formed into plasma (excited), with the result that films (outermost surface layers) corresponding to the material gas contained in the mixed gas formed into plasma (excited) are simultaneously deposited and formed on the surfaces of the belt precursor 175 of the first film-forming device 42b1 and the belt precursor 175 of the second film-forming device 42b2. In this case, the roll electrode 20a and the roll electrode 20b that are opposite to each other are disposed with a predetermined gap therebetween. Another mode may be used in which one of the roll electrode of the roll electrode 20a and the roll electrode 20b is connected to ground, with the other roll electrode being connected to the power supply. In this case, the second power supply is desirably used as the power supply so as to form a fine, solid thin film, in particular, when a rare gas, such as argon, is used as the discharge gas.

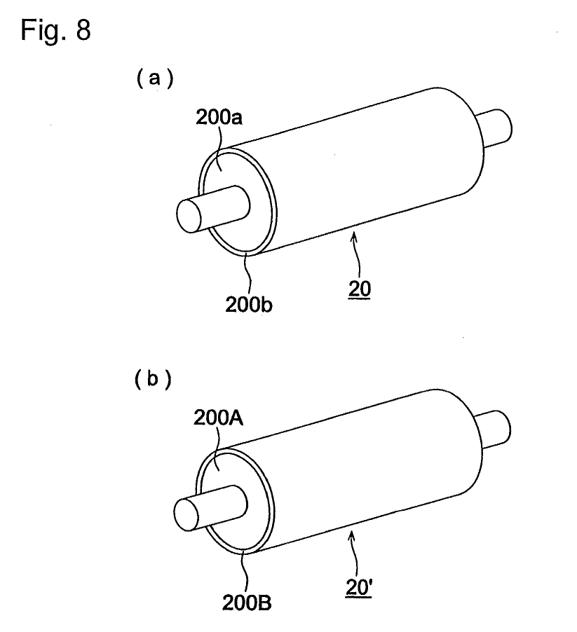

The following description will discuss in detail a mode of the atmospheric-pressure plasma CVD device for forming the outermost surface layer 4 on the belt precursor 175. In this case, FIG. 7 mainly indicates a broken-line portion of FIG. 5 in an extracted manner. FIG. 7 is an explanatory view showing a first plasma film-forming device used for manufacturing the outermost surface layer by using plasma. Referring to FIG. 7, the following description will discuss one example of an atmospheric-pressure plasma CVD device desirably used for forming the outermost surface layer 4.

The atmospheric-pressure plasma CVD device 43 is provided with at least one pair of rollers that are rotated and driven, with a belt precursor being detachably wound thereon, and at least one pair of electrodes that carry out a plasma discharge, with one of the paired electrodes forming one of the paired rollers, with the other electrode serving as a fixed electrode that opposes the one of the rollers with the belt precursor interposed therebetween. The atmospheric-pressure plasma CVD device 43 serves as a manufacturing device for the outermost surface layer in which the belt precursor is exposed to plasma generated in the opposing area between the one of the rollers and the fixed electrode so as to deposit and form the outermost surface layer, and, for example, in the case where a nitrogen gas is used as a discharge gas, by applying a high voltage from one of power supplies, with a high frequency being applied thereto from the other power supply, the discharging process is started stably and the discharge is maintained desirably. As described earlier, the atmospheric-pressure plasma CVD device 43 is provided with the mixed-gas supply device 24, the fixed electrode 21, the first power supply 25, a first filter 25a, the roll electrode 20, a driving means 20a that drives the roll electrode to rotate in an arrow direction, the second power supply 26, and a second filter 26a, and a mixed gas G formed by mixing a material gas and a discharge gas is excited by a plasma discharge exerted in the discharge space 23 so that the surface of the belt precursor 175a is exposed to the excited mixed gas G1 so as to deposit and form the outermost surface layer 4 on its surface. In this case, the first high-frequency voltage with a frequency of ω₁ is applied to the fixed electrode 21 from the first power supply 25, and the second high-frequency voltage with a frequency of ω₂ is applied to the roll electrode 20 from the second power supply 26 so that an electric field in which the frequency ω₁ with an electric-field intensity V₁ and the frequency ω₂ with an electric-field intensity V₂ are multiplexed is generated between the fixed electrode 21 and the roll electrode 20; thus, a current I₁ flows through the fixed electrode 21 and a current I₂ flows through the roll electrode 20, with a plasma being generated between the electrodes. In this case, the relationship between the frequency ωᵢ and the frequency ω₂, as well as the relationship among the electric-field intensity V₁, the electric-field intensity V₂ and the electric-field high intensity IV for initiating a discharge of a discharge gas, are made to satisfy ω₁<ω₂ and V₁≧V>V₂, or V₁>IV≧V₂, with the output density of the second high-frequency electric field being set to 1 W/cm² or more. Since the electric-field high intensity IV for initiating the nitrogen gas discharge is set to 3.7 kV/mm, at least the electric-field intensity Vᵢ to be applied from the first power supply 25 is preferably set to 3.7 kV/mm or more, while the electric-field intensity V₂ to be applied from the second high-frequency power supply 60 is preferably set to 3.7 kV/ram or less. As the first power supply 25 (high-frequency power supply) applicable to the first atmospheric-pressure plasma CVD device 43, the following commercial products are proposed, and any of these may be used.

Application Power-Supply Symbol Manufacturer Frequency Product Name

| | | | | |
|---|---|---|---|---|
| A1 | Shinko Electric Co., Ltd. | 3 | kHz | SPG3-4500 |
| A2 | Shinko Electric Co., Ltd. | 5 | kHz | SPG5-4500 |
| A3 | Kasuga Electric Works Ltd. | 15 | kHz | AGI-023 |
| A4 | Shinko Electric Co., Ltd. | 50 | kHz | SPG50-4500 |
| A5 | Haiden Laboratory Co., Ltd. | 100 | kHz* | PHF-6k |
| A6 | Pearl Kogyo Co., Ltd. | 200 | kHz | CF-2000- |
| | | | | 200k |
| A7 | Pearl Kogyo Co., Ltd. | 400 | kHz | CF-2000- |
| | | | | 400k |
| A8 | SEREN IPS | 100 to 460 | kHz | L3001 |

As the second power supply 26 (high-frequency power supply), the following commercial products are proposed, and any of these may be used.

Application Power-Supply Symbol Manufacturer Frequency Product Name

| | | | | |
|---|---|---|---|---|
| B1 | Peal Kogyo Co., Ltd. | 800 | kHz | CF-2000-800k |
| B2 | Peal Kogyo Co., Ltd. | 2 | MHz | CF-2000-2M |
| B3 | Peal Kogyo Co., Ltd. | 13.56 | MHz | CF-5000-13M |
| B4 | Peal Kogyo Co., Ltd. | 27 | MHz | CF-2000-27M |
| B5 | Peal Kogyo Co., Ltd. | 150 | MHz | CF-2000-150M |
| B6 | Peal Kogyo Co., Ltd. | 20 to 99.9 | MHz | RP-2000- |
| | | | | 20/100M |

Note that among the above-mentioned power supplies, the power supply indicated by symbol * is an impulse high-frequency power supply (100 kHz in continuous mode) made by Haiden Laboratory Co., Ltd. Those power supplies other than this are high-frequency power supplies to which only the continuous sine wave is applicable. In the present invention, as the power to be supplied between the opposing electrodes from the first and second power supplies, a power (output density) of 1 W/cm² or more is supplied to the fixed electrode 21 so that a discharge gas is excited to generate plasma and consequently to form a thin film. The upper limit value of the power to be supplied to the fixed electrode 21 is preferably set to 50 W/cm², more preferably, to 20 W/cm². The lower limit value thereof is preferably set to 1.2 W/cm². Note that the discharge area (cm²) refers to the area of a range in which a discharge is exerted by the electrode. By also supplying power (output density) of 1 W/cm² or more to the roll electrode 20, it is possible to improve the output density, with the uniformity of the high-frequency electric field being maintained. Thus, it becomes possible to generate a uniform plasma with higher density, and also to simultaneously improve the film-forming rate and the film quality. Preferably, it is set to 5 W/cm² or more. The upper limit value of power to be supplied to the roll electrode 20 is preferably set to 50 W/cm². In this case, the waveform of the high-frequency electric field is not particularly limited. There are a continuous oscillation mode with a continuous sine wave pattern referred to as a continuous mode and an intermittent oscillation mode that intermittently carries out ON/OFF processes referred to as a pulse mode, and either of these may be adopted; however, for the high frequency to be supplied at least to the roll electrode 20, the continuous sine wave, which provides a more finely-solid, higher quality film, is preferably used. A first filter 25a is installed between the fixed electrode 21 and the first power supply 25 so that a current is allowed to easily transmit from the first power supply 25 to the fixed electrode 21, while a current from the second power supply 26 is grounded so that a current is made to hardly transmit from the second power supply 26 to the first power supply 25, and a second filter 26a is installed between the roll electrode 20 and the second power supply 26 so that a current is allowed to easily transmit from the second power supply 26 to the roll electrode 20, while a current from the first power supply 25 is grounded so that a current is made to hardly transmit from the first power supply 25 to the second power supply 26. With respect to the electrode, it is preferable to adopt such an electrode that can maintain a uniform stable discharging state by applying a strong electric field thereto as described earlier, and in order to withstand a discharge derived from a strong electric field, at least one of the electrode surfaces of the fixed electrode 21 and the roll electrode 20 is coated with the following dielectric member. In the above-mentioned description, with respect to the relationship between the electrode and the power supply, the second power supply 26 may be connected to the fixed electrode 21, and the first power supply 25 may be connected to the roll electrode 20.

FIG. 8 is a schematic view showing one example of the roll electrode. The following description will discuss the structure of the roll electrode 20, and in FIG. 8(a), the roll electrode 20 is configured through combining processes in which, after a conductive base member 200a made of metal or the like (hereinafter, referred to also as “electrode base member”) has been flame-sprayed with ceramics, this is coated with a ceramic coating process dielectric member 200b (hereinafter, referred to also simply as “dielectric member”) that has been subjected to a pore-sealing process by using an inorganic material. As the ceramic material for use in the flame-spraying process, alumina, silicon nitride, or the like is preferably used, and among these, alumina is more preferably used because of its easiness of processing. As shown in FIG. 8(b), a roll electrode 20′, formed by a combining process in which a conductive base member 200A of metal or the like is coated with a lining-treated dielectric member 200B having an inorganic material formed thereon by a lining process, may be used. As the lining member, silicate-based glass, borate-based glass, phosphate-based glass, germanate-based glass, tellurite glass, aluminate glass, vanadate glass and the like are preferably used, and among these, borate-based glass is more preferably used because of its easiness of processing. As the conductive base members 200a and 200A made of metal or the like, metals, such as silver, platinum, stainless, aluminum, titanium and iron, are used, and stainless is preferably used because of its processability. In the present embodiment, a jacket roll base member made of stainless provided with a cooling means by the use of cooling water is used as the base members 200a and 200A of the roll electrode (not shown).

Referring to FIGS. 5 and 7, the following description will discuss in detail an example of a film-forming process for depositing and forming the outermost surface layer 4 on the belt precursor 175. In FIGS. 5 and 7, after passing the belt precursor 175 over the roll electrode 20 and the driven roller 201, a predetermined tension is applied to the belt precursor 175 by operating the tension applying means 202, and the roll electrode 20 is then driven to rotate at a predetermined number of revolutions. A mixed gas G is generated from the mixed gas supply device 24, and discharged into the discharge space 23. A voltage with a frequency ω₁ is outputted from the first power supply 25, and applied to the fixed electrode 21, and a voltage with a frequency ω₂ is outputted from the second power supply 26, and applied to the roll electrode 20 so that an electric field V in which the frequencies of ω₁ and ω₂ are multiplexed is generated in the discharge space 23 by these voltages. The mixed gas G, discharged into the discharge space 23, is excited by the electric field V to be formed into a plasma state. The surface of the belt precursor is exposed to the mixed gas G in the plasma state so that an outermost surface layer 4 is formed on the belt precursor 175 by the material gas in the mixed gas G. The outermost surface layer thus formed may be prepared as a plurality of layers to be formed into the outermost surface layer composed of the plurality of layers, and in this case, at least one layer of the plurality of layers is preferably allowed to contain carbon atoms in a range of 0.1 to 20% by mass, based upon the content measurements of carbon atoms by an XPS measuring method. For example, in the atmospheric-pressure plasma CVD device 43, a mixed gas (discharge gas) is plasma-excited between paired electrodes (roll electrode 20 and fixed electrode 21) so that the material gas containing carbon atoms located in this plasma is made into radicals and the surface of the belt precursor 175 is exposed to these. Thus, the surface of the belt precursor 175, exposed to carbon-containing molecules and carbon-containing radicals, is allowed to contain these in the outermost surface layer. The discharge gas refers to a gas that is plasma-excited under the above-mentioned conditions, and examples of the discharge gas include: nitrogen, argon, helium, neon, krypton, xenon and the like, and a mixture of these.

As the material gas for forming the outermost surface layer, an organic metal compound, which forms a gas or a liquid at normal temperature, in particular, an alkyl metal compound, a metal alkoxide compound and an organic metal complex compound, may be used. These materials are not necessarily required to have a gaseous phase at normal temperature and normal pressure, and may have a liquid phase or a solid phase as long as they are evaporated by fusion, evaporation, sublimation or the like through the heating or pressure-reducing process in the mixed gas supply device 24.

As the material gas, a material that is formed into a plasma state in a discharge space, and contains a component used for forming a thin film, such as an organic metal compound, an organic compound and an inorganic compound, is used.

In the case of forming a silicon oxide layer, a silicon compound is used. Specific examples of the silicon compound include: silane, tetramethoxysilane, tetraethoxysilane (TEOS), tetra n-propoxysilane, tetraisopropoxysilane, tetra n-butoxysilane, tetra t-butoxysilane, dimethyldimethoxysilane, dimethyldiethoxysilane, diethyldimethoxysilane, diphenyldimethoxysilane, methyltriethoxysilane, ethyltrimethoxysilane, phenyltriethoxysilane, (3,3,3-trifluoropropyl) trimethoxysilane, hexamethyldisiloxane, bis(dimethylamino)dimethylsilane, bis(dimethylamino)methylvinylsilane, bis(ethylamino)dimethylsilane, N,O-bis(trimethylsilyl)acetoamide, bis(trimethylsilyl)carbodiimide, diethylaminotrimethylsilane, dimethylaminodimethylsilane, hexamethyldisilazane, hexamethylcyclotrisilazane, heptamethyldisilazane, nonamethyltrisilazane, octamethylcyclotetrasilazane, tetrakisdimethylaminosilane, tetraisocyanatosilane, tetramethyldisilazane, tris(dimethylamino)silane, triethoxyfluorosilane, allyldimethylsilane, allyltrimethylsilane, benzyltrimethylsilane, bis(trimethylsilyl)acetylene, 1,4-bistrimethylsilyl-1,3-butadiyne, di-t-butylsilane, 1,3-disilabutane, bis(trimethylsilyl)methane, cyclopentadienyltrimethylsilane, phenyldimethylsilane, phenyltrimethylsilane, propagyltrimethylsilane, tetramethylsilane, trimethylsilylacetylene, 1-(trimethylsilyl)-1-propyne, tris(trimethylsilyl)methane, tris(trimethylsilyl)silane, vinyltrimethylsilane, hexamethyldisilane, octamethylcyclotetrasiloxane, tetramethylcyclotetrasiloxane, hexamethylcyclotetrasiloxane, M silicate 51 and the like; however, the present invention is not limited thereto.

In the case of forming a titanium oxide layer, a titanium compound is used. Specific examples of the titanium compound include: organic metal compounds such as tetradimethylaminotitanium, metal hydrogen compounds, such as monotitanium and dititanium, metal halogen compounds, such as titanium dichloride, titanium trichloride and titanium tetrachloride, and metal alkoxides, such as tetraethoxy titanium, tetraisopropoxy titanium and tetrabutoxy titanium; however, the present invention is not limited thereto.

For example, in the case of forming an aluminum oxide layer, an aluminum compound is used. Specific examples of the aluminum compound include: aluminum n-butoxide, aluminum s-butoxide, aluminum t-butoxide, aluminum diisopropoxideethylacetoacetate, aluminum ethoxide, aluminum hexafluoropentanedionate, aluminum isopropoxide, aluminum III2,4-pentanedionate and dimethyl aluminum chloride; however, the present invention is not limited thereto.

For example, in the case of forming a zinc oxide layer, a zinc compound is used. Specific examples of the zinc compound include: zinc bis(bis(trimethylsilyl)amide), zinc 2,4-pantanedionate and zinc 2,2,6,6-tetramethyl-3,5-heptanedionate; however, the present invention is not limited thereto.

For example, in the case of forming a zirconium oxide layer, a zirconium compound is used. Specific examples of the zirconium compound include: zirconium t-butoxide, zirconium diisopropoxidebis(2,2,6,6-tetramethyl-3,5-heptanedionate, zirconium ethoxy, zirconium hexafluoropentanedionate), zirconium isopropoxide, zirconium 2-methyl-2-butoxide and zirconium trifluoropentanedionate; however, the present invention is not limited thereto.

One of these materials may be used alone, or a mixture of two or more kinds of these may be used. As described earlier, the hardness of the outermost surface layer can be adjusted by the film-forming rate and the ratio of the amount of added gases.

Elastic Layer/Base Layer

The elastic layer 3 is an organic compound layer having elasticity. As the elastic material forming the elastic layer (elastic material rubbers, elastomers), one kind or two or more kinds of materials selected from the following group may be used. The group consists of butyl rubber, fluorine-based rubber, acryl rubber, EPDM, NBR, acrylonitrile-butadiene-styrene rubber, natural rubber, isoprene rubber, styrene-butadiene rubber, butadiene rubber, ethylene-propylene rubber, ethylene-propylene ter-polymer, chloroprene rubber, chlorosulfonated polyethylene, chlorinated polyethylene, urethane rubber, syndiotactic 1,2-polybutadiene, epichlorohydrin-based rubber, silicone rubber, fluorine rubber, polysulfide rubber, polynorbornane rubber, hydrogenated nitrile rubber, thermoplastic elastomer (for example, polystyrene-based, polyolefin-based, polyvinyl chloride-based, polyurethane-based, polyamide-based, polyurea-based, polyester-based and fluorine resin-based elastomers); however, needless to say, the present invention is not limited thereto.

A resistance-value adjusting conductive agent may be added to the elastic layer 3. Although not particularly limited, examples of the resistance-value adjusting conductive agent include: carbon black, graphite, metal powder, such as aluminum and nickel, and conductive metal oxides, such as tin oxide, titanium oxide, antimony oxide, indium oxide, potassium titanate, antimony oxide-tin oxide composite oxide (ATO) and indium oxide-tin oxide composite oxide (ITO). The conductive metal oxide may be coated with insulating fine particles, such as barium sulfate, magnesium silicate and calcium carbonate. The present invention is not limited to the above-mentioned conductive agents.

The surface roughness Rz of the elastic layer 3 is set within the same range as that of Rz of the outermost surface layer.

Although not particularly limited as long as the objective of the present invention is achieved, the thickness of the elastic layer is normally set in a range from 50 to 1000 μm, preferably, from 50 to 500 μm.

From the viewpoint of further suppressing the occurrence of filming, the hardness of the elastic layer is preferably set in a range from 20 to 60, more preferably, from 25 to 40.

The hardness of the elastic layer is measured in compliance with JIS-A hardness (Asker hardness), and indicated by an average value of measured values in arbitrary ten points obtained by using a hardness tester made by Shimadzu Corp.

The volume resistivity of the elastic layer is preferably set in a range from 10⁹ to 10¹³ Ω·cm, more preferably, from 10⁹ to 10¹⁰ Ω·cm.

The volume resistivity is indicated by an average value of measured values in arbitrary ten points obtained by using a Hirester made by Mitsubishi Chemical Analytech Co., Ltd.

The base layer 2 is an organic polymer compound layer. As the resin material forming the base layer, one kind or two or more kinds of materials selected from the following group may be used. The group consists of polycarbonate, fluorine-based resin (ETFE, PVDF), styrene-based resins (monopolymer or copolymer containing styrene or styrene substitute), such as polystyrene, chloropolystyrene, poly-α-methylstyrene, styrene-butadiene copolymer, styrene-vinyl chloride copolymer, styrene-vinyl acetate copolymer, styrene-maleic acid copolymer, styrene-acrylic acid ester copolymer (such as styrene-methylacrylate copolymer, styrene-ethylacrylate copolymer, styrene-butylacrylate copolymer, styrene-octylacrylate and styrene-phenylacrylate copolymer), styrene-methacrylic acid ester copolymer (such as styrene-methylmethacrylate copolymer, styrene-ethylmethacrylate copolymer and styrene-phenylmethacrylate copolymer), styrene-α-chloromethylacrylate copolymer and styrene-acrylonitrile-acrylate copolymer, methylmethacrylate resin, butylmethacrylate resin, ethylacrylate resin, butylacrylate resin, modified acrylic resin (such as silicone-modified acrylic resin, vinyl chloride resin-modified acrylic resin and acryl-urethane resin), vinyl chloride resin, styrene-vinyl acetate copolymer, vinyl chloride-vinyl acetate copolymer, rosin-modified maleic acid resin, phenolic resin, epoxy resin, polyester resin, polyesterpolyurethane resin, polyethylene, polypropylene, polybutadiene, polyvinylidene chloride, ionomer resin, polyurethane resin, silicone resin, ketone resin, ethylene-ethylacrylate copolymer, xylene resin, polyvinyl butyral resin, polyamide resin, polyimide resin, modified polyphenylene oxide resin and modified polycarbonate. However, the present invention is not limited to these materials.

A resistance-value adjusting conductive agent may be added to the base layer 2. As the resistance-value adjusting conductive agent, the same materials as those resistance-value adjusting conductive agents to be added to the elastic layer 3 may be used.

Although not particularly limited as long as the objective of the present invention is achieved, the thickness of the base layer 2 is normally set in a range from 50 to 200 μm, preferably, from 80 to 120 μm.

From the viewpoints of improving the rigidity and of ensuring the durability, the hardness of the base layer 2 is preferably set in a range from 0.1 GPa to 2 GPa.

The hardness of the base layer 2 is indicated by a value measured by the same method as that of the hardness of the outermost surface layer.

The volume resistivity of the base layer is preferably set in a range from 10⁹ to 10¹³ Ω·cm, more preferably, from 10¹⁰ to 10¹¹ Ω·cm.

As the method for forming the elastic layer 3 and the base layer 2, for example, a centrifugal molding method in which a material is poured into a rotating cylinder-shaped mold to form a belt-shaped layer, a coating method in which a material is spray-coated or dip-coated so as to form a layer, or an injection method in which a material is injected into a gap between an inner mold and an outer mold to form a belt-shaped layer, may be used. Upon forming the elastic layer, curing and drying processes are carried out by heating, if necessary. Upon forming the base layer, a drying process is carried out by heating, if necessary.

In the case where an intermediate transfer belt having a structure shown in FIG. 1(A) is manufactured, the order of the formations of the elastic layer 3 and the base layer 2 is not particularly limited, and, for example, after preliminarily forming the elastic layer by the centrifugal molding method, the base layer may be formed by the centrifugal molding method or the coating method. At this time, since the surface roughness of the inner circumferential face in the cylinder-shaped mold, as it is, is transferred onto the surface of the elastic layer, the surface roughness of the elastic layer can be controlled by adjusting the surface roughness of the inner circumferential face.

For example, after preliminarily forming the base layer by using the centrifugal molding method, the elastic layer may be formed by the centrifugal molding method or the coating method. In this case, by polishing the surface of the elastic layer, the surface roughness of the elastic layer can be controlled.

For example, after forming the elastic layer by using the injection mold method, the base layer may be formed by using the coating method. In this case, since the surface roughness of the inner circumferential face in the outer mold, as it is, is transferred onto the surface of the elastic layer, the surface roughness of the elastic layer can be controlled by adjusting the surface roughness of the inner circumferential face.

For example, after forming the base layer by using the injection mold method, the elastic layer may be formed by using the coating method. In this case, by polishing the surface of the elastic layer, the surface roughness of the elastic layer can be controlled.

In the case where an intermediate transfer belt having a structure shown in FIG. 1(B) is manufactured, the elastic layer 3 may be formed, for example, by the centrifugal molding method or the injection mold method. At this time, by adjusting the surface roughness of the inner circumferential face of the cylinder-shaped mold for use in the centrifugal molding method or the surface roughness of the inner circumferential face of the outer mold for use in the injection mold method, the surface roughness of the elastic layer can be controlled.

Image-Forming Apparatus

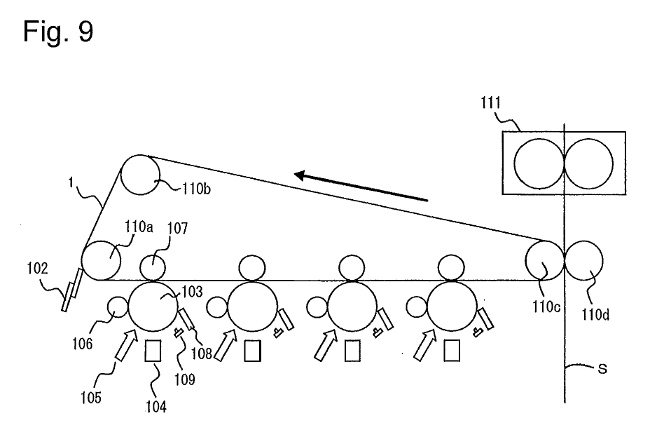

The intermediate transfer belt according to the present invention is used for an image-forming apparatus based upon an electrophotographic system, such as a copying machine, a facsimile and a laser printer, and when a toner image, formed on the surface of a photosensitive member, is transferred onto a recording material such as paper, the intermediate transfer belt is used for once supporting the toner image on its surface so as to be further transported. FIG. 9 shows one example of an image-forming apparatus in which the intermediate transfer belt of the present invention is used.

FIG. 9 is a schematic structural diagram showing a multi-color image-forming apparatus of a tandem-type that is one embodiment of an image-forming apparatus according to the present invention. In the present embodiment, the intermediate transfer belt of the present invention is represented by reference numeral “1”, and has an endless shape. The intermediate transfer belt 1 is wound around a driving roller 110a, a tension roller 110b and a backup roller 110c as a supporting member. Four image-forming units are disposed in a directly-connected state along the horizontal portion of the intermediate transfer belt 1. These image-forming units have substantially the same structure, but differ from one another in that they respectively form toner images of different colors, that is, yellow (Y) color, magenta (M) color, cyan (C) color and black (K) color.

First, the image-forming units will be described. Each of the image-forming units is provided with an electrophotographic photosensitive member (hereinafter, referred to as “photosensitive drum”) 103 that has a drum shape and serves as an image-supporting member placed so as to rotate. On the periphery of the photosensitive drum 103, processing devices, such as a primary charger 104 serving as a primary charging means, an exposing device 105 serving as an exposing means, a developing device 106 serving as a developing means, a transferring device 107 serving as a primary transferring means and a cleaning device 108 serving as a cleaning means, are installed. The other image-forming units also have the same structure. Specifically, each of the image-forming units has the photosensitive drum 103, the primary charger 104, the exposing device 105, the developing device 106, the transferring roller 107 and the cleaning device 108. The imago-forming units differ from one another in that they respectively form toner images of respective yellow, magenta, cyan and black colors. A developing vessel (not shown) is normally placed around the developing device 106 disposed in each of the image-forming units, and the respective developing vessels house yellow toner (yellow developer), magenta toner (magenta developer), cyan toner (cyan developer) and black toner (black developer).

Next, the following description will discuss image-forming operations of the image-forming apparatus having the above-mentioned structure. The photosensitive drum 103 is uniformly charged by the primary charger 104, and an image signal derived from a yellow color component of a document sent from the exposing device (electrostatic latent-image forming means) 105 is applied onto the photosensitive drum 103 through a polygon mirror and the like so that an electrostatic latent-image is formed thereon. Next, yellow toner is supplied from the developer 106 so that the electrostatic latent-image is developed as a yellow toner image. This yellow toner image is allowed to reach the primary transferring unit where the photosensitive drum 103 and the intermediate transfer belt 1 are brought into contact with each other, in response to the rotation of the photosensitive drum. In the present example, the transferring roller 107 is disposed in the primary transferring unit as the primary transferring means, and a primary transferring bias voltage is applied thereto. Thus, the yellow toner image on the photosensitive drum 103 is primarily transferred onto the intermediate transfer belt 1. The intermediate transfer belt 1 supporting the yellow toner image is transferred to the next image-forming unit. A magenta toner image, formed on the photosensitive drum in the image-forming unit by the same method as described above at this point of time, is transferred onto the yellow toner image in the primary transferring unit at which the transferring roller is placed. In the same manner, as the intermediate transfer belt proceeds in a direction indicated by an arrow, a cyan toner image and a black toner image are transferred and superposed on the above-mentioned toner image in the respective primary transferring units where the transferring rollers are placed in the same manner as described above. At this point of time, a recording material, sent from a paper-feeding cassette by paper-feeding roller and other transporting rollers, has reached the secondary transferring unit. In the secondary transferring unit, the secondary transferring device serving as the secondary transferring means, that is, a secondary transferring roller 110d (secondary transferring means) in the present example, is disposed face to face with the backup roller 110c in a manner so as to sandwich the intermediate transfer belt 1. A transferring bias voltage is applied to the secondary transferring roller 110d so that the above-mentioned toner images having four colors are transferred (secondarily transferred) onto the recording material S. The recording material on which the toner image has been transferred is transported to a fixing unit 111. In the fixing unit, the toner image is fixed on the recording material S by applying heat and pressure thereto. Residual transfer toner on the photosensitive drum 103 that has not been transferred in the primary transferring unit is cleaned by the cleaning device 108. Residual transfer toner on the intermediate transfer belt 1 that has not been transferred in the secondary transferring unit is cleaned by an intermediate transferring member cleaning device 102 serving as an intermediate transferring member cleaning means, and is again supplied to the next image-forming process.

### EXAMPLES

### Experimental Example A

### Method for Manufacturing Intermediate Transfer Belt Example 1A

First, an elastic layer made of urethane rubber was formed by using a centrifugal molding method. More specifically, a mixed material containing 13 parts by weight of toluene, 10 parts by weight of polyurethane elastomer and 3 parts by weight of carbon black was poured into a rotating cylinder-shaped mold and heated so that a belt-shaped elastic layer was formed. At this time, the surface roughness on the inner circumferential face of the cylinder-shaped mold, as it is, was transferred onto the surface of the elastic layer so that the elastic layer had surface roughness, hardness and thickness shown in Table 1.

Next, a base layer made from polyimide was formed by using a centrifugal molding method. More specifically, a mixed material containing 450 parts by weight of N-methyl-2-pyrrolidone, 35 parts by weight of 4,4′-diaminodiphenylether, 50 parts by weight of 3,3′,4,4′-biphenyltetracarboxylic acid dianhydride and 20 parts by weight of carbon black was poured into the cylinder-shaped mold on which the elastic layer was formed, and heated so that a base layer was formed on the inner side of the elastic layer. The base layer had a hardness of 1 GPa and a thickness of 100 μm.

Lastly, an inorganic compound layer was formed on the surface of the elastic layer by using an atmospheric-pressure plasma CVD device. More specifically, by using a first manufacturing device shown in FIG. 5, a silicon oxide layer was formed on the surface of the elastic layer by the use of tetraethoxysilane as the material gas. The silicon oxide layer had surface roughness, hardness and thickness shown in Table 1.

### Examples 2A to 18A/Comparative Examples 1A to 11A

Intermediate transfer belts were manufactured by using the same method as example 1A, except that the hardness of the elastic layer was controlled to a predetermined value by changing the thickness of the elastic layer, that the surface roughness of the elastic layer was controlled to a predetermined value by changing the surface roughness of the inner circumferential face of the mold, that the hardness of the inorganic compound layer was controlled to a predetermined value by changing the thickness of the inorganic compound layer and that the surface roughness of the inorganic compound layer was controlled to a predetermined value by changing the surface roughness of the elastic layer.

Evaluation of Filming

Each of the intermediate transfer belts produced as described above was installed in a bizhub 650 made by Konica Minolta Technologies, Inc., and continuous printing operations of 500,000 sheets were carried out by using an evaluation chart having a solid image of 50 mm 50 mm. The intermediate transfer belt had a circumferential length of 1000 mm and a moving speed V of 250 mm/sec. After the continuous printing operations, the surface on the image-forming side of the intermediate transfer belt was visually evaluated, and the image lastly printed was evaluated on its quality.

◯: There was no difference between the image portion and the non-image portion in the visual evaluation on the belt, and no problem was raised on the image quality;
Δ: In the visual evaluation on the belt, a difference was confirmed; however no problem was raised on the image quality (no problems in practical use);
x: Differences were confirmed between the image portion and the non-image portion in the visual evaluation on the belt as well as on the image quality.

TABLE 1

| | Elastic Layer | | | Inorganic Compound Layer | | | | |
|---|---|---|---|---|---|---|---|---|
| | | Thickness | Surface Roughness | | Hardness | Thickness | Surface Roughness | |
| | Asker Hardness | [μm] | Rz [μm] | Material | [GPa] | [nm] | Rz [μm] | Filming |
| Comparative Example 1A | 40 | 200 | 1.5 | SiO₂ | 9 | 200 | 1.5 | x |
| Example 1A | 40 | 200 | 3.0 | SiO₂ | 9 | 200 | 3.0 | ∘ |
| Example 2A | 40 | 200 | 5.0 | SiO₂ | 9 | 200 | 5.0 | ∘ |
| Example 3A | 40 | 200 | 7.0 | SiO₂ | 9 | 200 | 7.0 | ∘ |
| Example 4A | 40 | 200 | 9.0 | SiO₂ | 9 | 200 | 9.0 | ∘ |
| Example 5A | 40 | 200 | 12.5 | SiO₂ | 9 | 200 | 12.5 | Δ |
| Example 6A | 40 | 200 | 17.5 | SiO₂ | 9 | 200 | 17.5 | Δ |
| Comparative Example 2A | 40 | 200 | 25 | SiO₂ | 9 | 200 | 25 | x |
| Comparative Example 3A | 40 | 200 | 35 | SiO₂ | 9 | 200 | 35 | x |
| Comparative Example 4A | 30 | 300 | 1.5 | SiO₂ | 9 | 200 | 1.5 | x |
| Example 7A | 30 | 300 | 3.0 | SiO₂ | 9 | 200 | 3.0 | ∘ |
| Example 8A | 30 | 300 | 9.0 | SiO₂ | 9 | 200 | 9.0 | ∘ |
| Example 9A | 30 | 300 | 17.5 | SiO₂ | 9 | 200 | 17.5 | Δ |
| Comparative Example 5A | 30 | 300 | 25.0 | SiO₂ | 9 | 200 | 25.0 | x |
| Comparative Example 6A | 50 | 100 | 1.5 | SiO₂ | 9 | 200 | 1.5 | x |
| Example 10A | 50 | 100 | 3.0 | SiO₂ | 9 | 200 | 3.0 | ∘ |
| Example 11A | 50 | 100 | 9.0 | SiO₂ | 9 | 200 | 9.0 | ∘ |
| Example 12A | 50 | 100 | 17.5 | SiO₂ | 9 | 200 | 17.5 | Δ |
| Comparative Example 7A | 50 | 100 | 25.0 | SiO₂ | 9 | 200 | 25.0 | x |
| Comparative Example 8A | 40 | 200 | 1.5 | SiO₂ | 3 | 300 | 1.5 | x |
| Example 13A | 40 | 200 | 3.0 | SiO₂ | 3 | 300 | 3.0 | ∘ |
| Example 14A | 40 | 200 | 9.0 | SiO₂ | 3 | 300 | 9.0 | ∘ |
| Example 15A | 40 | 200 | 17.5 | SiO₂ | 3 | 300 | 17.5 | Δ |
| Comparative Example 9A | 40 | 200 | 25.0 | SiO₂ | 3 | 300 | 25.0 | x |
| Comparative Example 10A | 40 | 200 | 1.5 | SiO₂ | 15 | 100 | 1.5 | x |
| Example 16A | 40 | 200 | 3.0 | SiO₂ | 15 | 100 | 3.0 | ∘ |
| Example 17A | 40 | 200 | 9.0 | SiO₂ | 15 | 100 | 9.0 | ∘ |
| Example 18A | 40 | 200 | 17.5 | SiO₂ | 15 | 100 | 17.5 | Δ |
| Comparative Example 11A | 40 | 200 | 25.0 | SiO₂ | 15 | 100 | 25.0 | x |

### Experimental Example B

### Method for Manufacturing Intermediate Transfer Belt Example 1B

First, an elastic layer made of urethane rubber was formed by using a centrifugal molding method. More specifically, a mixed material containing 13 parts by weight of toluene, 10 parts by weight of polyurethane elastomer and 3 parts by weight of carbon black was poured into a rotating cylinder-shaped mold and heated so that a belt-shaped elastic layer was formed. At this time, the surface roughness on the inner circumferential face of the cylinder-shaped mold, as it is, was transferred onto the surface of the elastic layer so that the elastic layer had surface roughness, hardness and thickness shown in Table 2.

Next, an inorganic compound layer was formed on the surface of the elastic layer by using an atmospheric-pressure plasma CVD device. More specifically, by using a first manufacturing device shown in FIG. 5, a silicon oxide layer was formed on the surface of the elastic layer, by the use of tetraethoxysilane as a material gas. The silicon oxide layer had surface roughness, hardness and thickness as shown in Table 2.

### Examples 2B to 18B/Comparative Examples 1B to 11B

Intermediate transfer belts were manufactured by using the same method as example 1B, except that the hardness of the elastic layer was controlled to a predetermined value by changing the thickness of the elastic layer, that the surface roughness of the elastic layer was controlled to a predetermined value by changing the surface roughness of the inner circumferential face of the mold, that the hardness of the inorganic compound layer was controlled to a predetermined value by changing the thickness of the inorganic compound layer and that the surface roughness of the inorganic compound layer was controlled to a predetermined value by changing the surface roughness of the elastic layer.

Evaluation of Filming

By using the same method as that of experimental example A, each of the intermediate transfer belts was evaluated.

TABLE 2

| | Elastic Layer | | | Inorganic Compound Layer | | | | |
|---|---|---|---|---|---|---|---|---|
| | | Thickness | Surface Roughness | | Hardness | Thickness | Surface Roughness | |
| | Asker Hardness | [μm] | Rz [μm] | Material | [GPa] | [nm] | Rz [μm] | Filming |
| Comparative Example 1B | 40 | 200 | 1.5 | SiO₂ | 9 | 200 | 1.5 | x |
| Example 1B | 40 | 200 | 3.0 | SiO₂ | 9 | 200 | 3.0 | ∘ |
| Example 2B | 40 | 200 | 5.0 | SiO₂ | 9 | 200 | 5.0 | ∘ |
| Example 3B | 40 | 200 | 7.0 | SiO₂ | 9 | 200 | 7.0 | ∘ |
| Example 4B | 40 | 200 | 9.0 | SiO₂ | 9 | 200 | 9.0 | ∘ |
| Example 5B | 40 | 200 | 12.5 | SiO₂ | 9 | 200 | 12.5 | Δ |
| Example 6B | 40 | 200 | 17.5 | SiO₂ | 9 | 200 | 17.5 | Δ |
| Comparative Example 2B | 40 | 200 | 25 | SiO₂ | 9 | 200 | 25 | x |
| Comparative Example 3B | 40 | 200 | 35 | SiO₂ | 9 | 200 | 35 | x |
| Comparative Example 4B | 30 | 300 | 1.5 | SiO₂ | 9 | 200 | 1.5 | x |
| Example 7B | 30 | 300 | 3.0 | SiO₂ | 9 | 200 | 3.0 | ∘ |
| Example 8B | 30 | 300 | 9.0 | SiO₂ | 9 | 200 | 9.0 | ∘ |
| Example 9B | 30 | 300 | 17.5 | SiO₂ | 9 | 200 | 17.5 | Δ |
| Comparative Example 5B | 30 | 300 | 25.0 | SiO₂ | 9 | 200 | 25.0 | x |
| Comparative Example 6B | 50 | 100 | 1.5 | SiO₂ | 9 | 200 | 1.5 | x |
| Example 10B | 50 | 100 | 3.0 | SiO₂ | 9 | 200 | 3.0 | ∘ |
| Example 11B | 50 | 100 | 9.0 | SiO₂ | 9 | 200 | 9.0 | ∘ |
| Example 12B | 50 | 100 | 17.5 | SiO₂ | 9 | 200 | 17.5 | Δ |
| Comparative Example 7B | 50 | 100 | 25.0 | SiO₂ | 9 | 200 | 25.0 | x |
| Comparative Example 8B | 40 | 200 | 1.5 | SiO₂ | 3 | 300 | 1.5 | x |
| Example 13B | 40 | 200 | 3.0 | SiO₂ | 3 | 300 | 3.0 | ∘ |
| Example 14B | 40 | 200 | 9.0 | SiO₂ | 3 | 300 | 9.0 | ∘ |
| Example 15B | 40 | 200 | 17.5 | SiO₂ | 3 | 300 | 17.5 | Δ |
| Comparative Example 9B | 40 | 200 | 25.0 | SiO₂ | 3 | 300 | 25.0 | x |
| Comparative Example 10B | 40 | 200 | 1.5 | SiO₂ | 15 | 100 | 1.5 | x |
| Example 16B | 40 | 200 | 3.0 | SiO₂ | 15 | 100 | 3.0 | ∘ |
| Example 17B | 40 | 200 | 9.0 | SiO₂ | 15 | 100 | 9.0 | ∘ |
| Example 18B | 40 | 200 | 17.5 | SiO₂ | 15 | 100 | 17.5 | Δ |
| Comparative Example 11B | 40 | 200 | 25.0 | SiO₂ | 15 | 100 | 25.0 | x |

Although the present invention has been fully described by way of examples with reference to the accompanying drawings, it is to be noted that various changes and modifications will be apparent to those skilled in the art. Therefore, unless such changes and modifications depart from the scope of the present invention, they should be construed as being included therein.

### EFFECTS OF THE INVENTION

The present invention makes it possible to sufficiently suppress an occurrence of filming even in the case of endurance printing operations.

What is claimed is:

1. An intermediate transfer belt, comprising:
an elastic layer; and
an outermost surface layer formed on the elastic layer,
wherein the outermost surface layer is an inorganic compound layer having a surface roughness Rz from 2 to 20 μm.

2. The intermediate transfer belt of claim 1, wherein the outermost surface layer has a surface roughness Rz from 2 to 10 μm.

3. The intermediate transfer belt of claim 1, wherein the outermost surface layer has a thickness from 0.05 to 1.0 μm.

4. The intermediate transfer belt of claim 1, wherein the outermost surface layer has a hardness from 0.5 to 20 GPa.

5. The intermediate transfer belt of claim 1, wherein the inorganic compound layer is formed from metal oxides or metal nitrides.

6. The intermediate transfer belt of claim 1, wherein the elastic layer has a thickness from 50 to 1000 μm.

7. The intermediate transfer belt of claim 1, wherein the elastic layer has a JIS-A hardness from 20 to 60.

8. An image-forming apparatus, comprising:
an image-forming unit having an image-supporting member on which a toner image is formed; and
an intermediate transfer belt on which the toner image is transferred from the image-supporting member,
wherein the intermediate transfer belt comprises an elastic layer and an outermost surface layer formed on the elastic layer and containing an inorganic compound layer with a surface roughness Rz from 2 to 20 μm.

9. The image-forming apparatus of claim 8, wherein the outermost surface layer has a surface roughness Rz from 2 to 10 μm.

10. The image-forming apparatus of claim 8, wherein the outermost surface layer has a thickness from 0.05 to 1.0 μm.

11. The image-forming apparatus of claim 8, wherein the outermost surface layer has a hardness from 0.5 to 20 GPa.

12. The image-forming apparatus of claim 8, wherein the inorganic compound layer is formed from metal oxides or metal nitrides.

13. The image-forming apparatus of claim 8, wherein the elastic layer has a thickness from 50 to 1000 μm.

14. The image-forming apparatus of claim 8, wherein the elastic layer has a JIS-A hardness from 20 to 60.
